(19) United States
(12) Patent Application Publication
(10) Pub. No.: US 2023/0018144 A1
(43) Pub. Date: Jan. 19, 2023

(54) TILT BALL SWITCH

(71) Applicant: Tien-Ming CHOU, Taichung City (TW)

(72) Inventor: Tien-Ming CHOU, Taichung City (TW)

(21) Appl. No.: 17/664,288

(22) Filed: May 20, 2022

(30) Foreign Application Priority Data
Jul. 15, 2021 (TW) 110126008

(51) Int. Cl. H01H 35/02

(52) U.S. Cl. CPC H01H 35/02; H01H 2205/016

(57) ABSTRACT

A tilt ball switch includes an insulation housing, a conductive ball, and two conductive terminals that cooperate with the insulation housing to define a chamber space. Each of the conductive terminals includes an inner terminal member that has a tapering section. The conductive ball is disposed to be movable in the chamber space and is convertible between a conducting state, in which the conductive ball is located at the tapering sections so that the inner terminal members are conductively connected to each other, and a non-conducting state, in which the conductive ball is separated from the tapering sections so that the inner terminal members are prevented from being conductively connected.

### CROSS-REFERENCE TO RELATED APPLICATION

This application claims priority to Taiwanese Invention Patent Application No. 110126008, filed on Jul. 15, 2021.

### FIELD

The disclosure relates to a switch, and more particularly to a tilt ball switch.

### BACKGROUND

Referring to FIG. 1, a conventional tilt ball switch 9 disclosed in Taiwanese Invention Patent No. 1712060 includes an insulation shell body 91, two conductive terminals 92 and two conductive balls 93. The insulation shell body 91 surrounds an axis (A), and defines a disposing hole 911 that extends along the axis (A) and that is open at two opposite ends thereof along the axis (A). The conductive terminals 92 extend respectively through the opposite ends of the disposing hole 911 into the insulation shell body 91 to cooperatively close the disposing hole 911. The conductive terminals 92 cooperatively define a terminal gap 920 therebetween. Each of the conductive terminals 92 has an inner surrounding surface 921 that surrounds the axis (A), and an inner-end surface 922 and an outer-end surface 925 that are respectively connected to two opposite ends of the inner surrounding surface 921. For each one of the conductive terminals 92, the outer-end surface 925 cooperates with the inner surrounding surface 921 to define an accommodating space 923 opening toward another one of the conductive terminals 92. The inner surrounding surface 921 of each of the conductive terminals 92 has an annular groove section 924 that is recessed relative to the opposite ends of the inner surrounding surface 921 of the conductive terminal 92 so that the annular groove section 924 is farthest from the axis (A). The conductive balls 93 are respectively disposed and movable in the accommodating spaces 923 of the conductive terminals 92 such that the conventional tilt ball switch 9 is convertible between a conducting state and a non-conducting state. When the insulation shell body 91 is placed horizontally (i.e., the axis (A) surrounded by the insulation shell body 91 is parallel to a reference horizontal plane (H)) and is stationary, the conductive balls 93 are respectively located at the annular groove sections 924 of the conductive terminals 92 and are not in contact with each other, so that the conventional tilt ball switch 9 is in the non-conducting state. When the insulation shell body 91 is tilted, one of the conductive balls 93 rolls away from the annular groove section 924 of the respective one of the conductive terminals 92 to be in contact with the other one of the conductive balls 93 so that the conventional tilt ball switch 9 is in the conducting state. That is to say, when horizontally disposed, the conventional tilt ball switch 9 requires an external force to move to a sloping position so that the conventional tilt ball switch 9 is converted to the conducting state by the movements of the conductive balls 93. Therefore, it will be unsuitable for applications that require a tilt ball switch that is in the conducting state by default.

### SUMMARY

Therefore, an object of the disclosure is to provide a tilt ball switch that can achieve an effect that the prior art does not possesses.

According to the disclosure, the tilt ball switch includes an insulation housing, two conductive terminals and a conductive ball. The insulation housing includes a surrounding wall that surrounds an axis and that defines an accommodating space. The accommodating space has two open ends opposite to each other along the axis. The conductive terminals are respectively disposed at the open ends of the accommodating space. Each of the conductive terminals includes an inner terminal member and an outer terminal member. The inner terminal member extends along the axis into the accommodating space, and has an inner-end surface and an inner surrounding surface. The inner-end surface is configured to not be parallel to the axis, faces the inner-end surface of another one of the conductive terminals, and cooperates with the inner-end surface of another one of the conductive terminals to define a gap therebetween. The inner surrounding surface is connected to the inner-end surface, surrounds the axis, and has a contacting section that approaches the axis while extending away from another one of the conductive terminals, and a tapering section that is adjacent to the gap and that is farthest from the axis. The outer terminal member is separably mounted to the inner terminal member, closes the respective one of the open ends, and has a terminal surface that faces the accommodating space. The insulation housing cooperates with the inner surrounding surface and the terminal surface of each of the conductive terminals to define a chamber space. The conductive ball is disposed to be movable in the chamber space and is convertible between a conducting state, in which the conductive ball is located at the tapering sections of the conductive terminals and is in contact with the conductive terminals so that the inner terminal members are conductively connected to each other, and a non-conducting state, in which the conductive ball is separated from the tapering sections so that the inner terminal members are prevented from being conductively connected to each other.

### BRIEF DESCRIPTION OF THE DRAWINGS

Other features and advantages of the disclosure will become apparent in the following detailed description of the embodiment with reference to the accompanying drawings, of which:

FIG. 1 is a sectional view of a conventional tilt ball switch disclosed in Taiwanese Invention Patent No. 1712060;

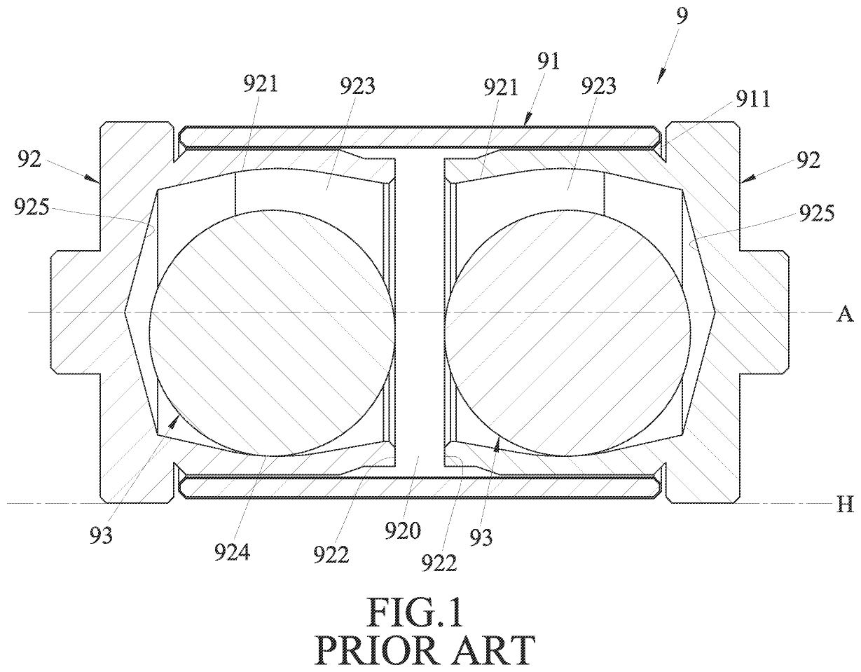

FIG. 2 is an exploded perspective view of an embodiment of a tilt ball switch according to the disclosure;

FIG. 3 is a side view of the embodiment;

FIG. 4 is a sectional view taken along line IV-IV in FIG. 3 illustrating a conductive ball of the embodiment in a conducting state; and

FIG. 5 is a sectional view illustrating the conductive ball in a non-conducting state.

### DETAILED DESCRIPTION

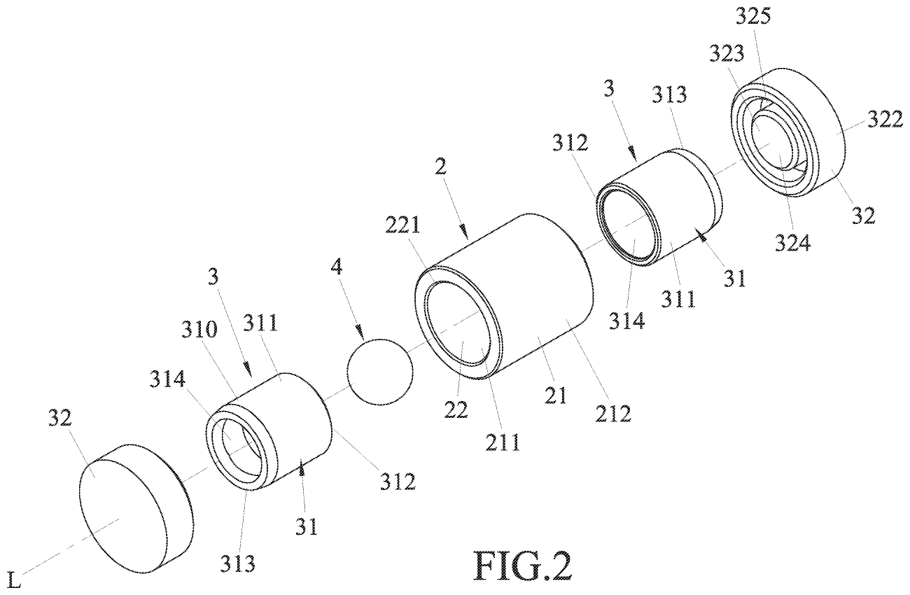

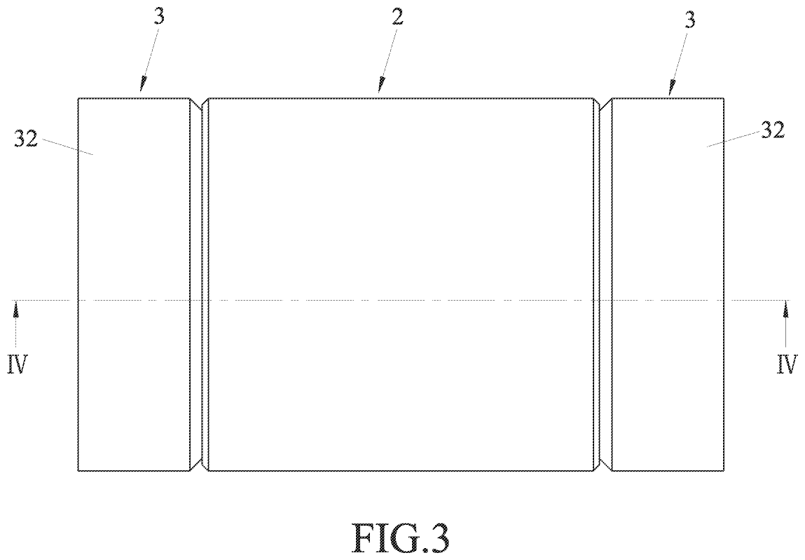

Referring to FIGS. 2 to 4, an embodiment of a tilt ball switch according to the disclosure includes an insulation housing 2, two conductive terminals 3 and a conductive ball 4.

The insulation housing 2 is configured to be in a shape of a hollow cylinder, and includes a surrounding wall 21 that surrounds an axis (L) and that defines an accommodating space 22. Specifically, the surrounding wall 21 has an inner wall surface 211 that surrounds the axis (L) and that defines the accommodating space 22, and an outer wall surface 212 that is opposite to the inner wall surface 211 and that surrounds the inner wall surface 211. The accommodating space 22 has two open ends 221 opposite to each other along the axis (L).

The conductive terminals 3 are spaced apart from each other along the axis (L) and are respectively disposed at the open ends 221 of the insulation housing 2. Each of the conductive terminals 3 includes an inner terminal member 31 and an outer terminal member 32. Each of the inner terminal members 31 is configured to be in a shape of a hollow cylinder and extends along the axis (L) into the accommodating space 22 of the insulation housing 2. For each conductive terminal 3, the outer terminal member 32 is separably mounted to the inner terminal member 31 and closes the respective one of the open ends 221 of the insulation housing 2. In this embodiment, the outer terminal member 32 is configured to be in a shape of a circular lid.

The inner terminal member 31 of each of the conductive terminals 3 has an inner-end part 311, an engaging-end part 310 opposite to the inner-end part 311, an inner-end surface 312, an outer-end surface 313 opposite to the inner-end surface 312, an inner surrounding surface 315, and an outer surrounding surface 319 opposite to the inner surrounding surface 315. The inner-end part 311 of each of the conductive terminals 3 is located in the accommodating space 22 of the insulation housing 2 and is spaced apart from another one of the conductive terminals 3 along the axis (L). The inner-end part 311 and the engaging-end part 310 of each of the conductive terminals 3 are respectively proximate to and distal from another one of the conductive terminals 3. The inner-end surface 312 of each of the conductive terminals 3 is located at the inner-end part 311 of the conductive terminal 3, is configured to not be parallel to the axis (L), faces the inner-end surface 312 of another one of the conductive terminals 3, and cooperates with the inner-end surface 312 of another one of the conductive terminals 3 to define a gap 33 therebetween. It is noted that, in this embodiment, the inner-end surface 312 is perpendicular to the axis (L) (i.e., an imaginary plane that extends from the inner-end surface 312 to the axis (L) is perpendicular to the axis (L)). However, in certain embodiments, the inner-end surface 312 may be oblique to the axis (L) (an imaginary plane that extends from the inner-end surface 312 to the axis (L) intersects the axis (L)). The outer-end surface 313 of each of the conductive terminals 3 is located at the engaging-end part 310 of the conductive terminal 3. For each conductive terminal 3, the inner surrounding surface 315 interconnects the inner-end surface 312 and the outer-end surface 313 and surrounds the axis (L), and the outer surrounding surface 319 interconnects the inner-end surface 312 and the outer-end surface 313, surrounds the inner surrounding surface 315 and abuts against the inner wall surface 211 of the insulation housing 2. For each conductive terminal 3, the inner surrounding surface 315 defines a through hole 314 that extends through the inner-end surface 312 and the outer-end surface 313, and has a contacting section 3150 that is located at the inner-end part 311 and that approaches the axis (L) while extending away from another one of the conductive terminals 3 (i.e., the contacting section 3150 approaches the axis (L) as it extends toward the engaging-end part 310), and a tapering section 316 that is adjacent to the gap 33 and that is farthest from the axis (L). For each conductive terminal 3, the through hole 314 has a small diameter section 317 that is located at the engaging-end part 310 and that is adjacent to the outer terminal member 32, and a large diameter section 318 that is located at the inner-end part 311, that is defined by the contacting section 3150 and the tapering section 316, that is adjacent to another one of the conductive terminals 3, and that has a diameter greater than a diameter (d2) of the small diameter section 317.

For each conductive terminal 3, the outer terminal member 32 is separably mounted to the engaging-end part 310 of the inner terminal member 31, and has a main body 322, a protrusion 323, an annular groove 325 and a terminal surface 324. The axis (L) extends through the main body 322. The protrusion 323 of each of the conductive terminals 3 protrudes from the main body 322 toward another one of the conductive terminals 3, and has the terminal surface 324. The terminal surface 324 faces the accommodating space 22 of the insulation housing 2 and is perpendicular to the axis (L). The annular groove 325 is indented from the main body 322 and surrounds the protrusion 323. The engaging-end part 310 of the inner terminal member 31 of each of the conductive terminals 3 extends into and engages the annular groove 325 of the outer terminal member 32 of the conductive terminal 3. The insulation housing 2 cooperates with the inner surrounding surface 315 and the terminal surface 324 of each of the conductive terminals 3 to define a chamber space 34.

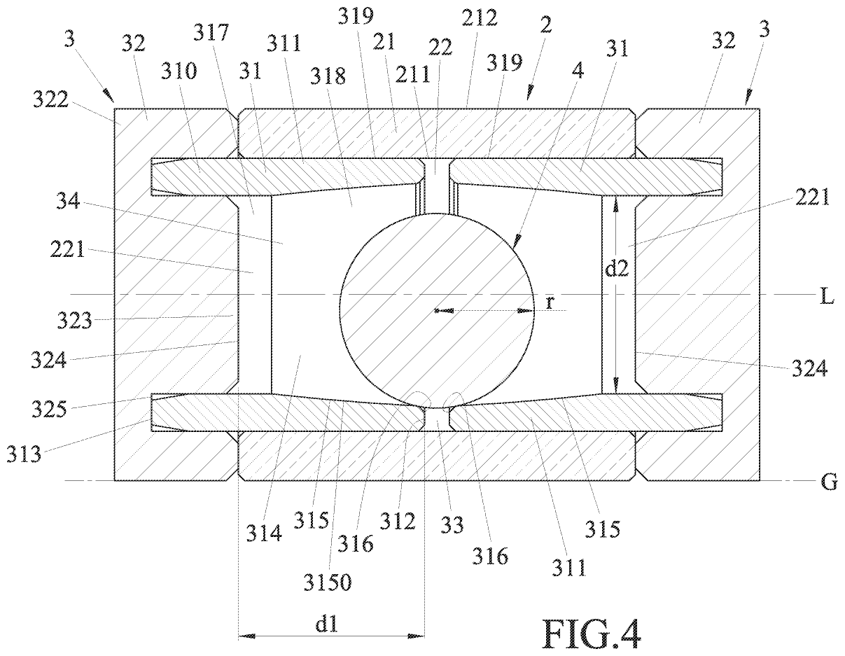

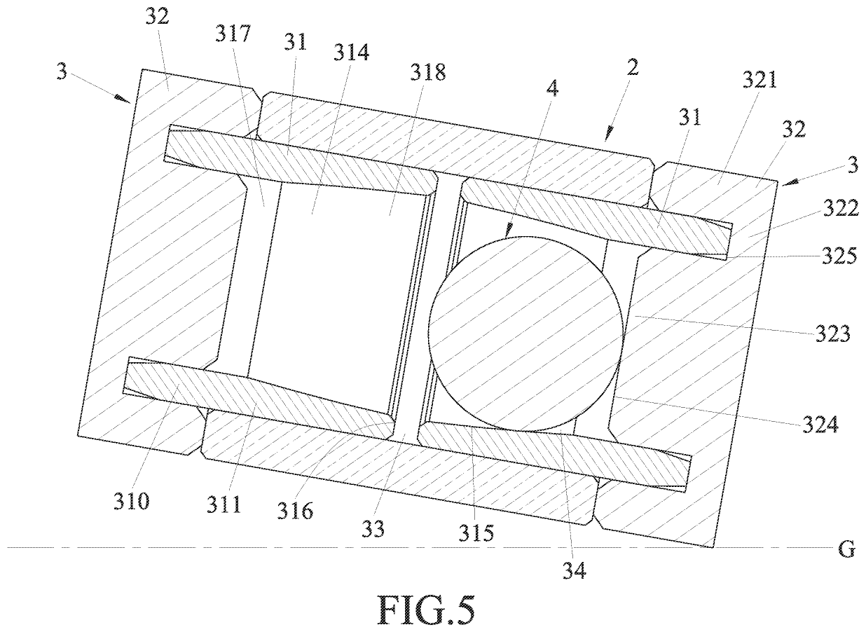

Referring further to FIG. 5, the conductive ball 4 is disposed to be movable in the chamber space 34 and is convertible between a conducting state (see FIG. 4), in which the conductive ball 4 is located at the tapering sections 316 of the conductive terminals 3 and is in contact with the inner-end parts 311 of the conductive terminals 3 so that the inner terminal members 31 are conductively connected to each other, and a non-conducting state, in which the conductive ball 4 is separated from the tapering sections 316 so that the inner terminal members 31 are prevented from being conductively connected to each other. Specifically, when the tilt ball switch is placed horizontally (i.e., the axis (L) is parallel to a reference horizontal plane (G)) and is stationary, the conductive ball 4 is located at the tapering sections 316 of the conductive terminals 3. At this time, the outer terminal members 32 are conductively connected to each other through the inner terminal members 31 and the conductive ball 4. Consequently, the tilt ball switch is in a closed state when at a horizontal position. When the tilt ball switch is tilted, the conductive ball 4 is only in contact with one of the inner terminal members 31. At this time, by virtue of the gap 33 between the the inner terminal members 31, the outer terminal members 32 are not conductively connected to each other. Therefore, the tilt ball switch is in an open state.

It is noted that, the inner terminal member 31 and the outer terminal member 32 of each of the conductive terminals 3 are separately manufactured before being assembled together.

In one embodiment, for each of the conductive terminals 3, a distance (d1) (see FIG. 4) between the inner-end surface 312 of the inner terminal member 31 and the terminal surface 324 of the outer terminal member 32 is greater than a radius (r) of the conductive ball 4, and is smaller than six times the radius (r) of the conductive ball 4. The diameter (d2) (see FIG. 4) of the small diameter section 317 of each of the conductive terminals 3 is greater than the radius (r) of the conductive ball 4, and is smaller than six times the radius (r) of the conductive ball 4. A distance between the terminal surfaces 324 of the conductive terminals 3 is no less than four times the radius (r) of the conductive ball 4. A width of the gap 33 defined by the inner-end surfaces 312 of the conductive terminals 3 along the axis (L) is smaller than two times the radius (r) of the conductive ball 4.

In another embodiment, the width of the gap 33 defined by the inner-end surfaces 312 of the conductive terminals 3 along the axis (L) is smaller than four-thirds of the radius (r) of the conductive ball 4.

In this embodiment, the distance between the terminal surfaces 324 of the conductive terminals 3 is four times the radius (r) of the conductive ball 4. The width of the gap 33 defined by the inner-end surfaces 312 of the conductive terminals 3 along the axis (L) is one-fourth of the radius (r) of the conductive ball 4.

By virtue of the width of the gap 33 being smaller than two times the radius (r) of the conductive ball 4, the conductive ball 4 may smoothly rolls across the gap 33. By virtue of the limitation of the distance (d1) between the inner-end surface 312 of the inner terminal member 31 and the terminal surface 324 of the outer terminal member 32, and by virtue of the limitation of the diameter (d2) of the small diameter section 317 of each of the conductive terminals 3, the conductive ball 4 may not be easily stuck in the through holes 314 of the conductive terminals 3.

When the tilt ball switch is in use, the outer terminal members 32 of the conductive terminals 3 are adapted to be electrically coupled to an external electric circuit (not shown). When the tilt ball switch is at a horizontal position and is stationary (i.e., the tilt ball switch is free from an external force), the conductive ball 4 is located at the tapering sections 316 of the conductive terminals 3 so that the outer terminal members 32 are conductively connected. At this time, the tilt ball switch is in the closed state so that electricity can flow through the tilt ball switch and the external electric circuit. When the tilt ball switch is tilted or shaken upon exertion of an external force, the conductive ball 4 is separated from the tapering sections 316 so that the outer terminal members 32 are not conductively connected. At this time, the tilt ball switch is in the open state.

In summary, by virtue of the contacting section 3150 of the inner surrounding surface 315 of each of the conductive terminals 3 approaching the axis (L) while extending away from another one of the conductive terminals 3, the conductive ball 4 is predisposed to be in the conducting state, in which the conductive ball 4 is located at the tapering sections 316 of the conductive terminals 3, when the tilt ball switch is at a horizontal position and is stationary. Consequently, the purpose of the disclosure is certainly fulfilled.

In the description above, for the purposes of explanation, numerous specific details have been set forth in order to provide a thorough understanding of the embodiment. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what is considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. A tilt ball switch comprising:
an insulation housing including a surrounding wall that surrounds an axis and that defines an accommodating space, said accommodating space having two open ends opposite to each other along the axis;
two conductive terminals respectively disposed at said open ends of said accommodating space, each of said conductive terminals including
an inner terminal member that extends along the axis into said accommodating space, and that has
an inner-end surface configured to not be parallel to the axis, facing said inner-end surface of another one of said conductive terminals, and cooperating with said inner-end surface of another one of said conductive terminals to define a gap therebetween, and
an inner surrounding surface connected to said inner-end surface, surrounding the axis, and having a contacting section that approaches the axis while extending away from another one of said conductive terminals, and a tapering section that is adjacent to said gap and that is farthest from the axis, and
an outer terminal member that is separably mounted to said inner terminal member, that closes the respective one of said open ends, and that has a terminal surface facing said accommodating space, said insulation housing cooperating with said inner surrounding surface and said terminal surface of each of said conductive terminals to define a chamber space; and
a conductive ball disposed to be movable in said chamber space and convertible between a conducting state, in which said conductive ball is located at said tapering sections of said conductive terminals and is in contact with said conductive terminals so that said inner terminal members are conductively connected to each other, and a non-conducting state, in which said conductive ball is separated from said tapering sections so that said inner terminal members are prevented from being conductively connected to each other.

2. The tilt ball switch as claimed in claim 1, wherein, for each of said conductive terminals, a distance between said inner-end surface of said inner terminal member and said terminal surface of said outer terminal member is greater than a radius of said conductive ball.

3. The tilt ball switch as claimed in claim 2, wherein, for each of said conductive terminals, the distance between said inner-end surface of said inner terminal member and said terminal surface of said outer terminal member is smaller than six times the radius of said conductive ball.

4. The tilt ball switch as claimed in claim 1, wherein a distance between said terminal surfaces of said conductive terminals is no less than four times a radius of said conductive ball.

5. The tilt ball switch as claimed in claim 1, wherein a width of said gap defined by said inner-end surfaces of said conductive terminals along the axis is smaller than two times a radius of said conductive ball.

6. The tilt ball switch as claimed in claim 1, wherein said inner terminal member and said outer terminal member of each of said conductive terminals are separately manufactured before being assembled together.

7. The tilt ball switch as claimed in claim 6, wherein:
said outer terminal member of each of said conductive terminals further has
a protrusion that protrudes toward another one of said conductive terminals and that has said terminal surface, and
an annular groove that surrounds said protrusion; and
said inner terminal member of each of said conductive terminals extends into and engages said annular groove of said outer terminal member of said conductive terminal.

8. The tilt ball switch as claimed in claim 7, wherein said inner terminal member of each of said conductive terminals further has an outer-end surface that is opposite to said inner-end surface, and a through hole that extends through said inner-end surface and said outer-end surface, and that is defined by said inner surrounding surface.

9. The tilt ball switch as claimed in claim 8, wherein:
for each of said conductive terminals, said through hole of said inner terminal member has a small diameter section that is adjacent to said outer terminal member, and a large diameter section that is defined by said contacting section and said tapering section, that is adjacent to another one of said conductive terminals, and that has a diameter greater than a diameter of said small diameter section; and
the diameter of said small diameter section of each of said conductive terminals is greater than the radius of said conductive ball, and is smaller than six times the radius of said conductive ball.
